(19) United States
(12) Patent Application Publication
(10) Pub. No.: US 2008/0317208 A1
(43) Pub. Date: Dec. 25, 2008

(54) Radiation Source and Method of Operating a Radiation Source in a Measurement Tool

(75) Inventors: Sascha Dieter, Ottendorf-Okrilla (DE); Andrea Lage, Dresden (DE); Martin Haberjahn, Dresden (DE)

Correspondence Address: EDELL, SHAPIRO & FINNAN, LLC, 1901 RESEARCH BLVD., SUITE 400, ROCKVILLE, MD, 20850, US

(73) Assignee: QIMONDA AG, Munich (DE)

(21) Appl. No.: 11/767,256

(22) Filed: Jun. 22, 2007

(51) Int. Cl. H01J 35/30

(52) U.S. Cl. 378/137

(57) ABSTRACT

A radiation source for a measurement tool includes an electron source configured to provide an electron beam, an anode configured to emit X-ray radiation under irradiation with the electron beam, and a deflection unit arranged between the electron source and the anode and operable to deflect the electron beam.

### BACKGROUND

Several techniques are known for performing measurements on the surface of a semiconductor wafer. In general, these techniques determine properties of a layer by using diffraction, absorption or electron-density related effects. These techniques include but are not limited to X-ray absorption spectroscopy, small-angle X-ray scattering, X-ray diffraction, X-ray fluorescence, X-ray photoelectron spectroscopy, X-ray reflectometry measurements. While some of these measurement techniques require an X-ray detector, some of them require detecting photo-emitted electrons or photons in an energy range different from the X-ray regime. Suitable detectors include but are not limited to semiconductor detectors or gas detectors. It is desirable to provide a radiation source and a method with improved variability and accuracy during measurements of a layer of an integrated circuit.

### SUMMARY

A radiation source for a measurement tool is described herein. The radiation source includes an electron source configured to provide an electron beam, an anode configured to emit X-ray radiation under irradiation with the electron beam, and a deflection unit arranged between the electron source and the anode and operable to deflect the electron beam.

The above and still further features and advantages of the present invention will become apparent upon consideration of the following definitions, descriptions and descriptive figures of specific embodiments thereof, wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

The radiation source and method of operation are explained in more detail below with reference to accompanying drawings, where:

FIG. 1 illustrates a system for measurement of a wafer;

FIG. 2 illustrates a semiconductor wafer in a top view;

FIG. 3 illustrates an X-ray source according to an embodiment;

FIG. 4 illustrates an X-ray source according to an embodiment;

FIG. 5A illustrates a beam profile of an X-ray source according to a further embodiment;

FIG. 5B illustrates a beam profile of an X-ray source according to a further embodiment;

FIG. 5C illustrates a beam profile of an X-ray source according to a further embodiment;

FIG. 5D illustrates a beam profile of an X-ray source according to a further embodiment; and

FIG. 6 illustrates a flow chart of method steps for performing a measurement.

### DETAILED DESCRIPTION

Embodiments of a radiation source and methods of using a radiation source are discussed in detail below. It is appreciated, however, that the present invention provides many applicable inventive concepts that can be embodied in a wide variety of specific contexts. The specific embodiments discussed are merely illustrative of specific ways and do not limit the scope of the invention.

In the following, embodiments of the method and the radiation source are described with respect to improving variability and accuracy during measurements of a layer of an integrated circuit. The embodiments, however, might also be useful in other respects, e.g. reduction in processing time, improvements in measurement system design or improvements in characterization of deposition tools.

Furthermore, it should be noted that the embodiments are described with respect to test patterns but might also be useful in other respects including but not limited to dense patterns, semi dense patterns or patterns with isolated lines and combinations between all them. Lithographic projection can also be applied during manufacturing of different products, e.g. semiconductor circuits, thin film elements. Other products, e.g., liquid crystal panels or the like might be produced as well.

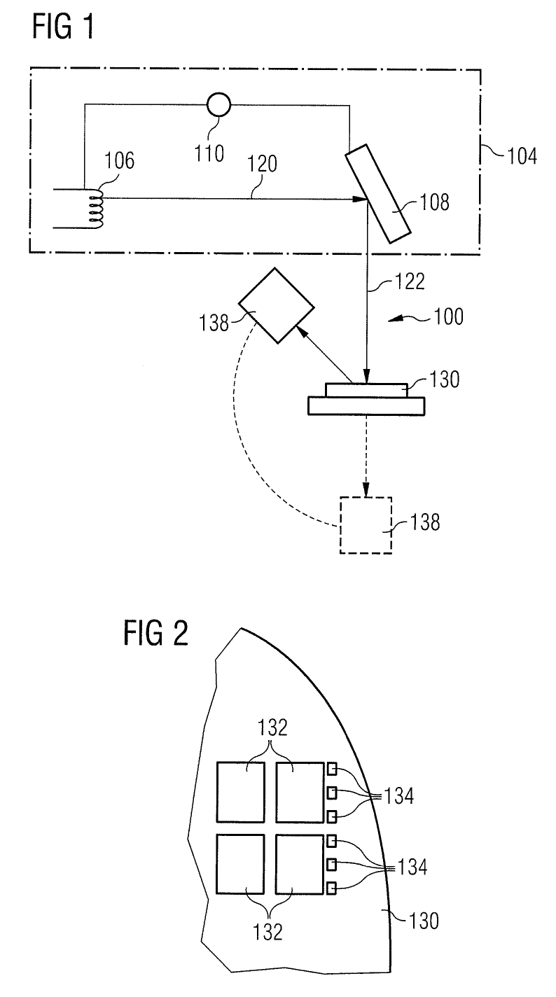

With respect to FIG. 1 a measurement tool 100 is shown in a side view. It should be appreciated that FIG. 1 merely serves as an illustration, i.e., the individual components shown in FIG. 1 neither describe the full functionality of a measurement tool nor are the elements shown to true scale.

The measurement tool 100 comprises a radiation source 104, which is, e.g., an X-ray source emitting X-ray radiation having energy between 1 keV and 250 keV. The radiation source 104 includes an electron source 106 and an anode 108. In one embodiment, the electron source 106 can be a filament comprising a suitable electrically conductive material (e.g., aluminum or tungsten). The filament is connected to a voltage source, (not shown in FIG. 1), which heats the filament in order to generate emission of an electron beam 120. It should be noted, however, that other types of electron sources 106 are known in the art which are not based on heating of a filament, which can be used in other embodiments.

The electron beam 120 provided by the electron source 106 hits the anode 108 and thus produces X-ray radiation directing partially towards a semiconductor wafer 130 as depicted by 122 in FIG. 1. The electron source 106 and the anode 108 are connected to a voltage source 110 thus operating as anode and cathode in order to accelerate electrons forming an electron beam 120 on the way from the cathode (i.e., electron source 106) to anode 108.

For the anode 108, suitable materials can be tungsten, molybdenum, copper, cobalt, iron, chrome, or silver. Other materials including various mixtures or alloys can be used as well. Furthermore, the electron source 106 and the anode 108 can be constructed as separate units which can be connected by a flange.

It should be noted that the measurement tool 100 as depicted in FIG. 1 serves only as an illustration and can have further components in order to provide full functionality, for example, vacuum tubes and corresponding systems, an escape window for X-ray beam 122 or a cooling unit for anode 108.

During operation, the anode is heated up due to the bombardment with electrons from electron beam 120. The intensity of X-ray beam 122 depends on the energy and the intensity of the primary electron beam 120, which can under spot like irradiation only to be increased up to a certain level in order to keep the thermal budget for the anode 108.

Before discussing modes of operation of measurement tool 100 in detail, a top view on semiconductor wafer 130 as a typical measurement object is depicted in FIG. 2. As shown in FIG. 2, the semiconductor wafer 130 can have several first structured or unstructured surface parts, which result in a circuit or chip block 132 after manufacturing. Each chip block 132 is surrounded by a kerf line which allows separating the individual chip blocks 132 to form single integrated circuits. The kerf line includes a second surface part, which includes one or more test structures 134. Since the test structures 134 do not add functionality to the fabricated integrated circuits it is desirable to keep the area occupied by the test structures 134 low. Today applications include, e.g., a 100 μm by 100 μm test structure 134.

During production of integrated circuits, the semiconductor wafer 130 can for example be coated using an atomic layer deposition procedure which allows covering the surface of the semiconductor wafer with a molecular layer of a predetermined thickness in order to create a specific layer of an integrated circuit.

In order to investigate the properties of the layer coating, an X-ray measurement can be performed on the test structure 134 after, e.g., the atomic layer deposition procedure has been performed. The test structure 134 can be used to determine layer thickness, chemical composition, crystal structure, phase properties or the like.

In order to perform such measurements on the surface of the semiconductor wafer, several techniques are known in the art. In general, these techniques determine properties of a layer by using diffraction, absorption or electron-density related effects. These techniques include but are not limited to X-ray absorption spectroscopy, small-angle X-ray scattering, X-ray diffraction, X-ray fluorescence, X-ray photoelectron spectroscopy, X-ray reflectometry measurements. While some of these measurement techniques require an X-ray detector 138, some of them require detecting photo-emitted electrons or photons in an energy range different from the X-ray regime. Suitable detectors include but are not limited to semiconductor detectors or gas detectors. Furthermore, reflectivity measurements can be made either successively as a function of the azimuth angle within the surface plane of the semiconductor wafer or perpendicular to the surface plane, for example. It is also conceivable to provide a plurality of detectors in order to perform measurements for different angles or locations at the wafer simultaneously.

Common to all these techniques is that feasibility of the measurement, measurement quality, and measurement time depends on the provided intensity of the X-ray beam within the measurement spot. Furthermore, the thickness of the layer is usually small, which results in a high background signal from scattered X-rays and from material in the volume around the measurement spot. Accordingly, an increased intensity of the X-ray beam within the measurement spot reduces the measurement time and, in some applications even more important, can increase the signal to background ratio.

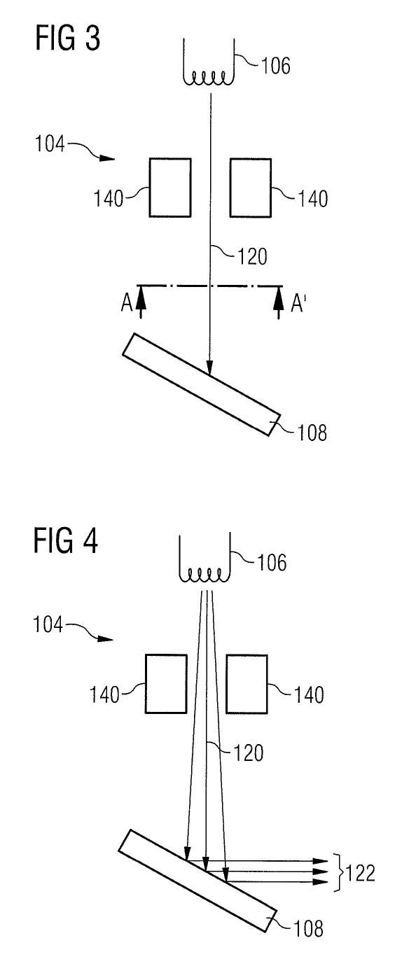

In order to increase the intensity of radiation source 104 and to obtain a measurable signal, in addition to the elements already explained with respect to FIG. 1, a deflection unit 140 is present between the electron source 106 and anode 108, as shown in FIG. 3. Deflection unit 140 can be a set of electromagnetic coils or a set of capacitor plates which can be used to deflect the electron beam 120. It is also conceivable to employ a mixture between electromagnetic coils and capacitor plates or to employ further elements which perform in addition beam focusing tasks. The set of electromagnetic coils can be a pair of coils being arranged opposite to each other and allowing the electron beam 120 to pass between deflection unit 140. A similar arrangement can be chosen for the capacitor plates. In the following, exemplary embodiments with electromagnetic coils are described, however, it is to be understood that other embodiments for a deflection unit 140 are conceivable and likewise would be covered by the present invention.

As shown in FIG. 3, the deflection unit 140 (i.e., the pair of coils) can deflect the electron beam 120, when operated with a suitable voltage signal. The deflection can be described in a plane being perpendicular to the incident undeflected electron beam 120. The plane can, for example, include the cross section along line A-A′, (shown in FIG. 3). It should be noted that a plane perpendicular to the incident undeflected electron beam 120 spans with the surface plane of anode 108 a tilt angle. The tilt angle can be selected in order to allow the X-ray radiation to leave anode 108 in a predetermined direction. A suitable range for the tilt angle can be, for example, from only a few degrees up to around 20°. Other configurations employ several sets of coils being arranged cylindrically around the incident undeflected electron beam 120. As shown below, the deflection unit can deflect the electron beam 120 in several dimensions so as to provide an oscillating or rotating beam spot. Furthermore, the voltage signal for operation of the deflection unit 140 can change periodically so as to deflect the electron beam 120 differently for different measurement times in a continuous fashion.

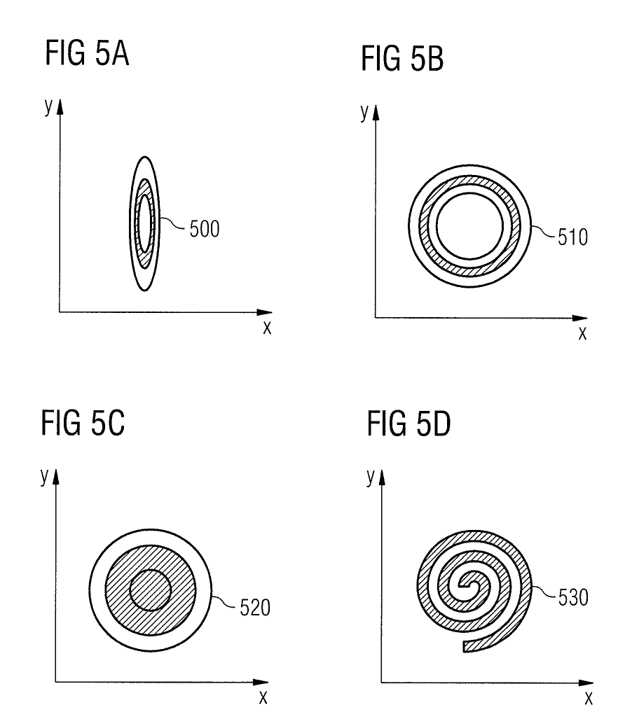

Making now reference to FIGS. 4 and 5A, a first mode of operation of radiation source 104 is further described. Here, the deflection unit 140 includes two electromagnetic coils which are operated so as to deflect the electron beam 120 in a transversal alternating position on the anode 108, i.e., along line A-A′. The alternating movement of electron beam 120 can be periodical. As a result, the beam spot over a longer time interval is shaped similar as a line. The resulting beam spot 500 on anode 108 is depicted in FIG. 5A. Consequently, the size of the beam spot 500 can be controlled by the amount of deflection in deflection unit 140.

Another mode of operation is depicted with reference to FIGS. 4 and 5B. There, the deflection unit 140 is further capable of deflecting electron beam 120 in more dimensions by employing further electromagnetic coils, so as to periodically rotate the position of the electron beam 120 on the anode 108. Thus, the resulting beam spot 510, which is depicted in FIG. 5B, is shaped as a circle. The radius of the resulting circular beam spot 510 depends on the amplitude of the deflection in deflection unit 140.

It should be noted that the above embodiments are only exemplary. It is within the scope of the invention to provide other suitable patterns for a beam spot, e.g., elliptical shaped beam spots or beam spots being shaped as lines having different orientations or being bent.

Furthermore, it is also possible to operate the deflection unit 140 such that it is adapted to widen the electron beam 120. Accordingly, a beam spot 520 results, which has an increasing cross section on the anode 108, as depicted in FIG. 5C. Here, the diameter of the resulting beam spot 520 depends on the amplitude of the deflection in deflection unit 140.

A further mode of operation is depicted with reference to FIGS. 4 and 5D. There, the deflection unit 140 is further capable of deflecting electron beam 120 in more dimensions by employing further electromagnetic coils, for example, periodically rotating the position of the electron beam 120 on the anode 108 with increasing radius. Thus, the resulting beam spot 530, which is depicted in FIG. 5D, is shaped as a coil. When reaching the outmost radial position, the deflection unit can, for example, deflect the electron beam back to its starting position either directly or on a spiral trajectory.

In summary, all above described concepts result in an increased area of the electron beam 120 on the anode 108 thus allowing higher intensities of the generated X-ray beam 122 due to reduced thermal stress at the anode 108. Furthermore, the size of the beam spot can be variably selected which allows for customizing the beam spot size according to the performed measurement. In addition, the tilt angle between the plane perpendicular to the incident undeflected electron beam 120 and the surface plane of anode 108 can be adjusted differently for the above described widened or periodically deflected electron beam in order to minimize losses of X-ray radiation within anode 108.

As a result, the radiation source 104 is capable to provide X-ray radiation for X-ray absorption spectroscopy, small-angle X-ray scattering, X-ray diffraction, X-ray fluorescence, X-ray photoelectron spectroscopy, X-ray reflectometry measurements which require high intensity X-ray radiation. If lower intensities are sufficient or spot like X-ray beams are required, the deflection unit 140 can be switched in an operating state in which the electron beam 120 is not deflected. Accordingly, the radiation source 104 can be switched between several modes of operation and allows selecting appropriate X-ray intensities, spot sizes and spot cross sections depending on the type of measurement which needs to be performed. However, it is also conceivable that the radiation source 104 is capable to vary spot size and overall intensity of X-ray radiation depending on the measurement task in a continuous mode without discrete switching states.

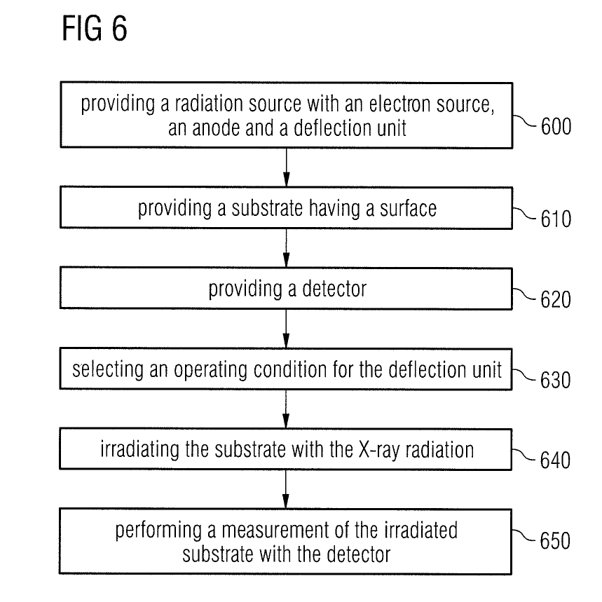

An embodiment of a method of operating the radiation source 104 is further described making reference to FIG. 6. In step 600, a radiation source with an electron source, an anode and a deflection unit is provided.

In step 610, a substrate having a surface is provided and in step 620 a detector is provided.

In step 630, an operating condition for the deflection unit is selected. The operating conditions can include operating the radiation source with a periodically deflected beam (e.g., in a circular or transversal alternating fashion), or with a widened beam.

In step 640 the surface of the substrate is irradiated with the X-ray radiation and in step 650 a measurement of the irradiated substrate is performed with the detector. The measurement can be X-ray diffraction, X-ray fluorescence, X-ray photoelectron spectroscopy, X-ray reflectometry measurements or measurements, for example, after atomic layer deposition.

While the invention has been described in detail with reference to specific embodiments thereof, it will be apparent to one of ordinary skill in the art that various changes and modifications can be made therein without departing from the spirit and scope thereof. Accordingly, it is intended that the present invention covers the modifications and variations of this invention provided they come within the scope of the appended claims and their equivalents.

What is claimed is:

1. A radiation source in a measurement tool, comprising:
an electron source configured to provide an electron beam;
an anode configured to emit X-ray radiation in response to being irradiated with the electron beam; and
a deflection unit arranged between the electron source and the anode and configured to deflect the electron beam.

2. The radiation source according to claim 1, wherein the deflection unit comprises an electromagnetic coil.

3. The radiation source according to claim 2, wherein the deflection unit comprises a pair of electromagnetic coils being arranged substantially opposite to one another allowing the electron beam to pass between the pair of electromagnetic coils.

4. The radiation source according to claim 1, wherein the deflection unit comprises a capacitor plate.

5. The radiation source according to claim 4, wherein the deflection unit comprises a pair of capacitor plates being arranged substantially opposite to one another allowing the electron beam to pass between the pair of capacitor plates.

6. The radiation source according to claim 1, wherein the deflection unit is configured to periodically change a position of the electron beam on the anode.

7. The radiation source according to claim 6, wherein a circular rotating position of the electron beam on the anode occurs in response to the periodical changing of the position of the electron beam on the anode.

8. The radiation source according to claim 6, wherein a transversal alternating position of the electron beam on the anode occurs in response to the periodical changing of the electron beam on the anode.

9. The radiation source according to claim 1, wherein the deflection unit is configured to increase a cross section of the electron beam on the anode.

10. The radiation source according to claim 1, wherein the anode and the electron source are configured to provide X-ray radiation between 1 keV and 250 keV, inclusive.

11. The radiation source according to claim 1, wherein the radiation source is configured to provide X-ray radiation to measure X-rays.

12. The radiation source according to claim 1, wherein the radiation source is configured to provide large spot size high overall intensity X-ray radiation in a first mode of operation and small spot size lower overall intensity X-ray radiation in a second mode of operation.

13. The radiation source according to claim 1, further comprising:
an adjustor to adjust a tilt angle between an undeflected electron beam and the anode.

14. A method of operating a radiation source for a measurement tool, the method comprising:
providing a radiation source including:
an electron source configured to transmit an electron beam,
an anode configured to emit X-ray radiation in response to being irradiated with the electron beam; and
a deflection unit with selectable operating conditions, arranged between the electron source and the anode, configured to deflect the electron beam;
selecting an operating condition for the deflection unit;
irradiating a substrate with the X-ray radiation; and
performing a measurement of the irradiated substrate with a detector.

15. The method according to claim 14, wherein the deflection unit comprises an electromagnetic coil or a capacitor plate.

16. The method according to claim 14, wherein the deflection unit comprises a pair of electromagnetic coils arranged substantially opposite to one another allowing the electron beam to pass between the pair of electromagnetic coils.

17. The method according to claim 14, wherein the deflection unit comprises a pair of capacitor plates arranged substantially opposite to one another allowing the electron beam to pass between the pair of capacitor plates.

18. The method according to claim 14, wherein the deflection unit is configured to periodically change a position of the electron beam on the anode.

19. The method according to claim 18, wherein a circular rotating position of the electron beam on the anode occurs in response to the periodical changing of the position of the electron beam on the anode.

20. The method according to claim 18, wherein a transversal alternating position of the electron beam on the anode occurs in response to the periodical changing of the position of the electron beam on the anode.

21. The method according to claim 14, wherein the deflection unit is configured to increase a cross section of the electron beam on the anode.

22. The method according to claim 14, wherein the anode and the electron source are configured to provide X-ray radiation between 1 keV and 250 keV, inclusive.

23. The method according to claim 14, wherein the performed measurement is a measurement selected from the group comprising: X-ray radiation for X-ray absorption spectroscopy, small-angle X-ray scattering, X-ray diffraction, X-ray fluorescence, X-ray photoelectron spectroscopy and X-ray reflectometry.

24. The method according to claim 14, wherein the radiation source is configured to variably provide large spot size high overall intensity X-ray radiation in a first mode of operation and small spot size lower overall intensity X-ray radiation in a second mode of operation.

25. The method according to claim 14, wherein the radiation source is configured to vary spot size and overall intensity of X-ray radiation depending on the measurement to be performed.

26. The method according to claim 14, further comprising:
adjusting a tilt angle between an undeflected electron beam and the anode.

27. A measurement tool, comprising:
a radiation source including:
an electron source configured to transmit an electron beam;
an anode configured to emit X-ray radiation in response to being irradiated with the electron beam; and
a deflection unit, arranged between the electron source and the anode, configured to deflect the electron beam;
a substrate holder configured to hold a substrate having a surface;
a detector operable to perform a measurement of the irradiated substrate; and
a selector operable to select an operating condition for the deflection unit.
